(19) United States
(12) Patent Application Publication
(10) Pub. No.: US 2003/0094162 A1
(43) Pub. Date: May 22, 2003

(54) Engine air-assisted injection compressor drive

(76) Inventor: Steven R. Baldwin, Troy, MI (US)

Correspondence Address: LESLIE C. HODGES, General Motors Corporation, Legal Staff, Mail Code 482-C23-B21, P.O. Box 300, Detroit, MI, 48265-3000, US

(21) Appl. No.: 09/992,256

(22) Filed: Nov. 19, 2001

(51) Int. Cl. F02M 23/00

(52) U.S. Cl. 123/533; 123/198 C

(57) ABSTRACT

An engine mounts an air compressor for supplying pressurized air to air-assist fuel injectors. The compressor is driven by an engine camshaft already utilized for actuating valve gear. The air compressor is mounted on an end of the engine, preferably adjacent the rear end of the camshaft, which in turn is driven directly by the crankshaft through a chain or gear train. In certain embodiments, the air compressor has an input shaft mounting a driven gear that engages a drive gear on the rear end of the camshaft, the camshaft and the air compressor drive shaft being rotatable on spaced parallel axis. Alternative external, internal and conical gear drive arrangements are disclosed. Direct drive of a compressor connecting rod by a crankpin on the camshaft is also disclosed. The simplified drives minimize added components and costs for the compressor attachment.

### TECHNICAL FIELD

This invention relates to internal combustion engines and, more particularly, to drive arrangements for an engine-mounted air compressor directly driven by an auxiliary shaft of an engine.

### BACKGROUND OF THE INVENTION

It is known in the art relating to internal combustion engines to provide for air-assisted injection of fuel directly into the engine cylinders. For this purpose, a high pressure air compressor may be mounted on the engine for supplying pressurized air to air-assisted fuel injectors of the engine. An air compressor for this purpose may be separately driven by an electric motor or may be driven by the engine through an accessory belt drive. Either arrangement adds to the components of the engine and accessory package and involves additional cost. Thus, development of a compressor drive having a minimum of extra components and reduced cost was desired.

### SUMMARY OF THE INVENTION

The present invention provides simplified air compressor drives for engines including cylinders adapted for direct injection of fuel by air assist fuel injectors supplied with pressurized air from an engine-mounted compressor. In a preferred embodiment, a compressor drive utilizes an auxiliary shaft in the form of an engine-mounted camshaft already utilized for actuating valve gear for admitting and exhausting fuel, air and combustion products to and from the engine. The air compressor is mounted on an end of the engine, preferably adjacent the rear end of the camshaft, which in turn is driven directly by the crankshaft through a chain or gear train connected with the engine crankshaft. In certain embodiments, the air pump has an input shaft mounting a driven gear that engages a drive gear on the rear end of the camshaft. The camshaft and air compressor input shaft are rotatable on spaced parallel axes. Various gear-driven embodiments include engaged external gears, engaged internal/external gears, and engaged conical internal/external gears where one of the gears is spring biased to take up misalignment and tooth lash in the gear drive.

Another embodiment utilizes a crank or eccentric to directly contact a drive element in the compressor, which in turn actuates a working member, such as a piston or diaphragm, for providing the pressurized air. The crank or cam may connect with a connecting rod or journal surface, either of which is directly connected with the working member to provide reciprocation of the member for compressing the air. The rod or eccentric may optionally be provided with balancing means in the form of a counterweight on the camshaft, offsetting the eccentric mass of the crank or cam.

The various auxiliary shaft compressor drive arrangements utilize a minimum of extra components for driving the air compressor and accordingly minimize the cost of adding a compressor to provide for air-assist fuel injection into the engine cylinders.

These and other features and advantages of the invention will be more fully understood from the following description of certain specific embodiments of the invention taken together with the accompanying drawings.

### BRIEF DESCRIPTION OF THE DRAWINGS

FIG. 1 is a pictorial view of a semi-exploded partial engine assembly having a first embodiment of air compressor drive using external gears according to the invention;

FIG. 2 is a view similar to FIG. 1 showing an alternative embodiment of air compressor drive utilizing internal/external gears;

FIG. 3 is a view similar to FIG. 2 but showing a modified embodiment utilizing conical internal/external gears;

FIG. 4 is an exploded pictorial view of the spring-loaded conical pump driven gear assembly of the embodiment of FIG. 3;

FIG. 5 is a view similar to FIG. 1 but showing an alternative embodiment wherein a crankpin on the camshaft engages a connecting rod in the air compressor for directly driving the working piston of the compressor; and

FIG. 6 is an exploded pictorial view showing the crankshaft and connecting assembly of FIG. 5.

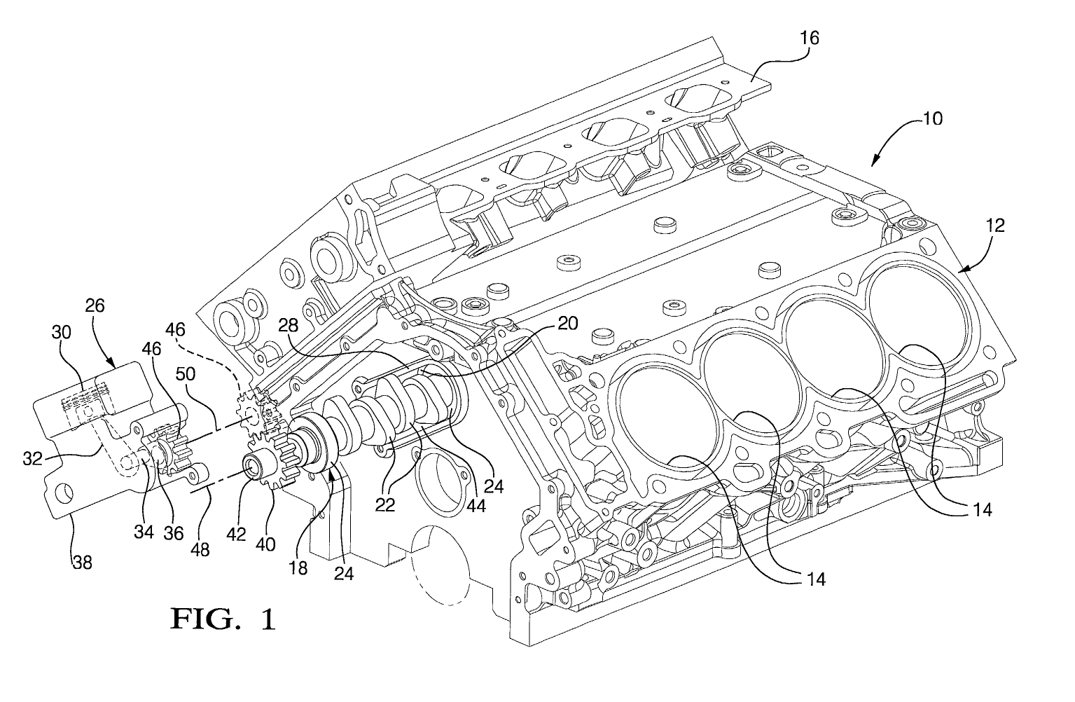

### DESCRIPTION OF THE PREFERRED EMBODIMENT

Referring now to the drawings in detail, numeral 10 generally indicates a reciprocating piston internal combustion engine shown in partial assembly with portions of the assembly in exploded form to illustrate their relationship. The partially-assembled engine includes a cylinder block 12 having two banks of cylinders 14. A cylinder head 16 is mounted on one of the cylinder banks while the other is shown without the cylinder head and valve gear which are provided in the fully-assembled engine. The engine also includes pistons in the cylinders joined by connecting rods to a crankshaft mounted in the lower portion of the block, all of which is conventional and is omitted from the drawings for simplicity.

Engine 10 is also provided with a camshaft 18 which is carried within the cylinder block 12 for rotation on internal bearings 20. The shaft 18 is conventionally driven from the crankshaft by a chain or other timing drive arrangement conventionally located at the front end, not shown, of the engine block. The camshaft includes cams 22 for actuating portions of the engine valve gear, not shown, and spaced bearing journals 24 rotatable within the associated bearings 20 of the cylinder block.

In accordance with the invention, the engine is further provided with a high pressure air compressor 26 which is mounted to a rear wall 28 of the engine cylinder block. Compressor 26 may be of any suitable construction and includes a working member such as a reciprocating piston 30 connected by a drive element such as a connecting rod 32 with an eccentric crankpin on the end of a driven shaft 36 rotatably supported in a body 38 of the air compressor. In the embodiment shown, the compressor 26 is provided for supplying pressurized air to air-assist fuel injectors, not shown, which are mounted in the engine for delivering fuel mixed with the pressurized air directly to the engine cylinders during engine operation. The form and operation of air-assist injectors in an engine is well known and forms no part of the present invention.

In accordance with the invention, the air compressor 26 is actuated by a compressor drive which includes a drive gear 40 mounted on a rear end 42 of the camshaft 18. The drive gear is mounted rearward of the rear bearing journal 24 and is enclosed, in assembly, within an opening 44 provided in the rear wall 28 of the engine cylinder block 12. Drive gear 40 engages a driven gear 46 which is mounted at the front end of the driven shaft 36 of the air compressor 26. As shown, drive and driven gears 40, 46 are external gears rotatable on parallel axes 48, 50 of the camshaft and driven shaft 18, 36, respectively. The gears shown are spur gears but they could be of helical or other suitable gear forms if desired. Also, the camshaft could be mounted in one of the cylinder heads rather than in the cylinder block, and the compressor could be mounted in any suitable location on the engine where engagement of its driven gear with the drive gear could be provided.

In operation of the engine, the crankshaft, not shown, rotates the camshaft 18 for actuating the engine valve gear in conventional fashion. Rotation of the camshaft turns the drive gear 40 which in turn rotates the driven gear 46, actuating the air pump to provide the required pressurized air for use with the air-assist fuel injectors or for other purposes if desired. Positioning of the drive and driven gears of the camshaft and compressor, respectively, within or inward of the rear wall 28 of the engine allows the drive to be lubricated by the engine oil along with the bearings and other internal moving components of the engine. The simplicity of the compressor drive and its use of the camshaft as a source of actuation provides a simple drive arrangement utilizing a minimum of extra components for actuating the compressor needed for the air-assist injectors intended for use in the engine. The gear drive also allows the air compressor to be driven at a desired speed, relative to camshaft speed, by selection of the relative diameters of the drive and driven gears.

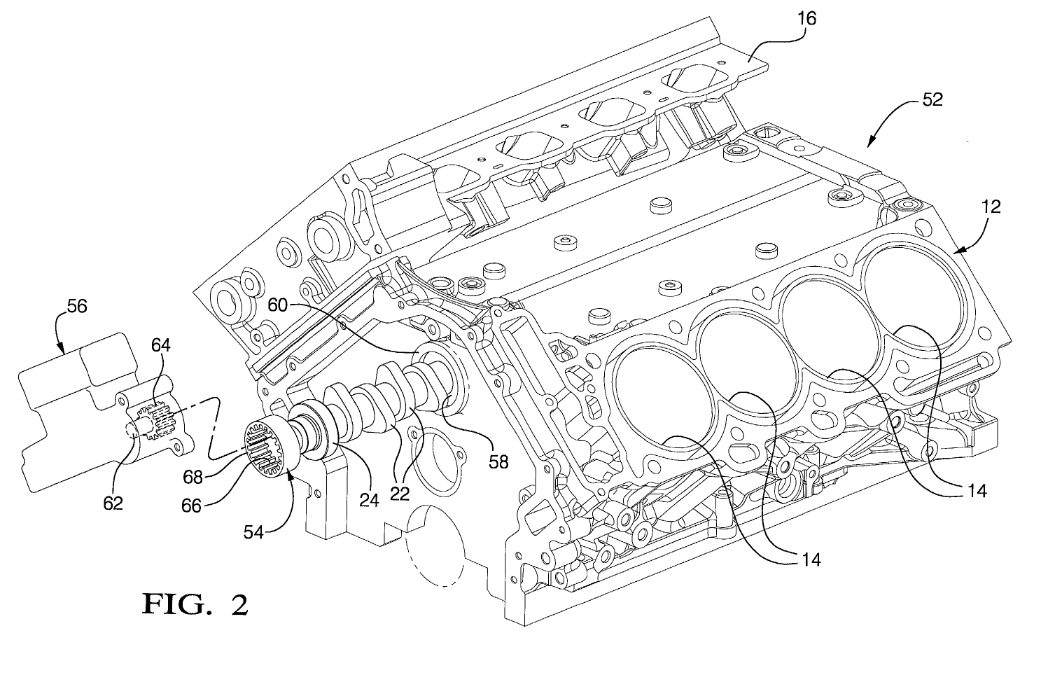

Referring now to FIG. 2, there is shown an engine 52 having many components identical to those of engine 10 and wherein like numerals indicate like parts. Engine 52 differs primarily in the form of the compressor drive as it relates to the camshaft 54 and the air compressor 56 and its mounting to the opening 58 in the rear wall 60 of the engine 52.

Compressor 56 is configured similarly to compressor 26 of the first described embodiment except that the driven shaft 62 of compressor 56 is provided with a smaller external gear 64 that engages the interior of an internal gear 66 mounted on the rear end 68 of the camshaft 54. As before, the two gears 64, 66 are mounted on spaced parallel axis, not shown, but the spacing is less than in the first embodiment by reason of the internal/external gear connection. The compressor 56 is again mounted on the rear wall 60 of the engine, although the compressor and the camshaft could be otherwise located in the cylinder head or other location if desired. The drive arrangement of FIG. 2 requires that the compressor be driven at a speed faster than the camshaft by reason of the necessarily smaller diameter of gear 64 than that of gear 66.

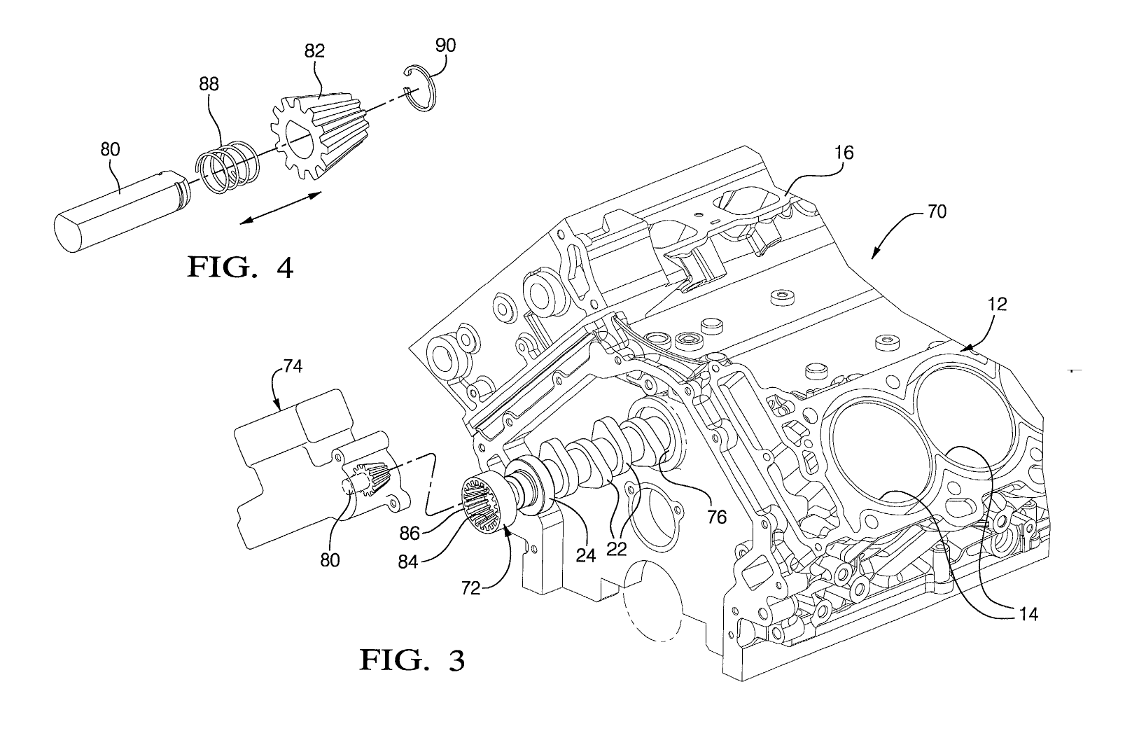

FIGS. 3 and 4 pertain to a third embodiment of the invention as installed in an engine 70 and wherein like reference numerals indicate like parts. This third embodiment differs from that of FIG. 2 again in the form of the compressor drive which includes the camshaft 72 and air compressor 74 mounted to an opening 76 in the rear wall 78 of the engine. The driven shaft 80 of the compressor mounts an external gear 82 which engages an internal gear 84 at the rear end 86 of the camshaft. The gears 82, 84 are formed with conical teeth and the external gear 82 is made slidable on the driven shaft 80 and is urged by a spring 88 forward into engagement with the internal teeth of gear 84. A clip 90 prevents external gear 82 from becoming detached from shaft 80 prior to installation of the compressor on the engine.

In operation, the spring 88 urges the external gear 82 forward into engagement with the internal gear, taking up the gear lash and accommodating some misalignment of the gear axes. It should be understood that gears 82, 84 also are rotatable on spaced parallel axes, not shown, and that the compressor is inherently rotated at a speed faster that the camshaft by reason of the internal/external gear drive arrangement. It would, of course, be possible to change the gear arrangement so that the internal gear was on the compressor and the external gear on the camshaft so that the speed change could be in the opposite direction.

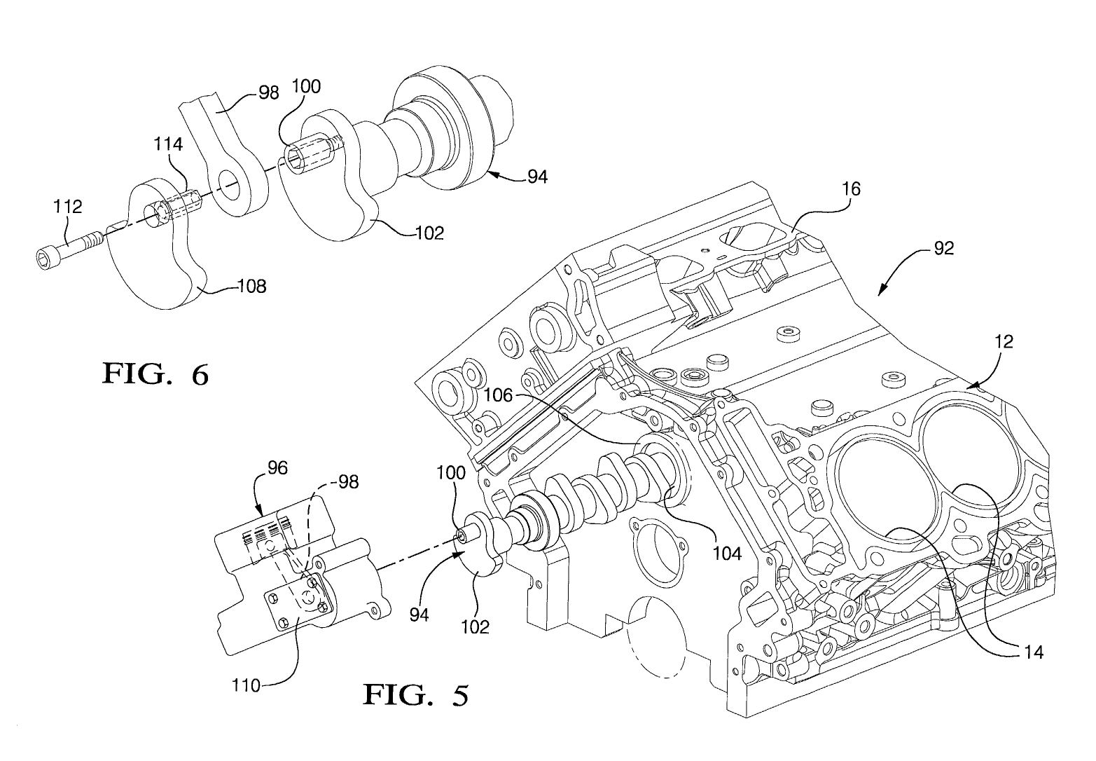

Referring now to FIGS. 5 and 6, a fourth embodiment of the invention is disclosed as installed in an engine 92 having similarities to the other engines and wherein like numerals indicate like parts. This embodiment differs in the construction of the camshaft 94 and the compressor 96 in that a connecting rod 98 in the compressor connects directly with an offset crankpin 100 on a crank and counterweight 102 formed as part of the camshaft 94. When the compressor 96 is mounted over the opening 104 in the rear wall 106 of the engine, the crankpin 100 engages the connecting rod 98. A second counterweight 108 is then installed through a removable cover 110 in the compressor outer wall and is retained by a screw 112 extending through a phase control pin 114.

Thus, when the camshaft is rotated by the engine crankshaft, not shown, the orbiting crankpin 100 drives the connecting rod 98 to reciprocate an attached piston or other pressure developing device, not shown, to directly actuate the air compressor 96. Obviously, the speed of operation of the compressor in this embodiment is identical with the rotational speed of the camshaft which directly operates the compressor piston. In this embodiment, the gear connection is completely dispensed with and the internal crank usually provided in the compressor is provided on the camshaft itself, further simplifying the drive arrangement from those of the first three embodiments described.

While the invention has been described by reference to certain preferred embodiments, it should be understood that numerous changes could be made within the spirit and scope of the inventive concepts described. Accordingly, it is intended that the invention not be limited to the disclosed embodiments, but that it have the full scope permitted by the language of the following claims.

1. An engine including at least one cylinder, an air compressor mounted on the engine and adapted to supply pressurized air to an air-assist fuel injector for delivering pressurized air and fuel mixtures to the cylinder, and a compressor drive for directly driving the compressor from the engine, said drive comprising:
an auxiliary shaft rotatably mounted in the engine and adapted to be driven by an output shaft of the engine for actuating various engine components;
the air compressor being mounted on an end of the engine and including a drive element for actuating a working member in the compressor to provide the pressurized air; and
connecting means drivably connecting one end of the auxiliary shaft with the drive element for actuating the working member.

2. An engine as in claim 1 wherein the auxiliary shaft is a camshaft for actuating valve gear of the engine.

3. An engine as in claim 1 wherein the drive element is a drive shaft of the compressor and the connecting means are drive and driven gears on the auxiliary shaft and the compressor drive shaft, respectively.

4. An engine as in claim 3 wherein the auxiliary shaft and the drive shaft are rotatable on parallel axes.

5. An engine as in claim 4 wherein the gears are engaged external gears rotatable on said axes.

6. An engine as in claim 4 wherein the gears are engaged internal and external gears rotatable on said axes.

7. An engine as in claim 6 wherein the gears are conical gears, one of the gears being axially movable and biased toward engagement with the other gear to accommodate misalignment and take up lash between the engaged gear teeth.

8. An engine as in claim 1 wherein the connecting means is a crank/eccentric.

9. An engine as in claim 8 including a counterweight on the auxiliary shaft and balancing the eccentric mass of the crank/eccentric.

10. An engine as in claim 1 wherein the connecting means is a crank and the drive element is a connecting rod connected between the crank and the working member.
